(19) United States
(12) Patent Application Publication
(10) Pub. No.: US 2009/0310694 A1
(43) Pub. Date: Dec. 17, 2009

(54) APPARATUS AND METHOD FOR TRANSMITTING AND RECEIVING MAP INFORMATION IN A BROADBAND WIRELESS COMMUNICATION SYSTEM

(75) Inventor: Chang-Yoon OH, Yongin-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/482,362

(22) Filed: Jun. 10, 2009

(30) Foreign Application Priority Data
Jun. 12, 2008 (KR) 10-2008-0055030

(51) Int. Cl. H04L 27/28

(52) U.S. Cl. 375/260

(57) ABSTRACT

A broadband wireless communication system and method are provided. The method includes allocating an orthogonal sequence to a MAP that requires ACKnowledge (ACK) transmission, transmitting the MAP that does not comprise allocation information of the orthogonal sequence, determining whether the orthogonal sequence is detected in an ACK channel allocated for a subframe that carries the MAP, and determining that the MAP is successfully received when the orthogonal sequence is detected.

### PRIORITY

This application claims the benefit under 35 U.S.C. §119(a) of a Korean patent application filed in the Korean Intellectual Property Office on Jun. 12, 2008 and assigned Serial No. 10-2008-0055030, the entire disclosure of which is hereby incorporated by reference.

### BACKGROUND OF THE INVENTION

1. Field of the Invention

The present invention relates to a broadband wireless communication system. More particularly, the present invention relates to an apparatus and a method for transmitting and receiving MAP information in the broadband wireless communication system.

2. Description of the Related Art

The 4th-Generation (4G) communication system, which is a future communication system, is under development to provide users with services having various Quality of Service (QoS) levels at a transfer rate of about 100 Mbps. In particular, the 4G communication system is advancing in order to support high-speed services by guaranteeing mobility and QoS in Broadband Wireless Access (BWA) communication systems such as wireless local area network systems and wireless metropolitan area network systems. Its representative examples include a communication system based on the Institute of Electrical and Electronics Engineers (IEEE) 802.16 standard. The IEEE 802.16 communication system adopts an Orthogonal Frequency Division Multiplexing (OFDM)/Orthogonal Frequency Division Multiple Access (OFDMA) scheme to support a broadband transmission network in physical channels.

In the broadband wireless communication system such as the communication system based on the IEEE 802.16 standard, resources are allocated to terminals block by block by occupying a certain region of the frequency axis and a certain region of the time axis. Accordingly, a base station transmits information relating to the resource allocation, and the terminal locates its allocated resource block based on the resource allocation information. Herein, the information relating to the resource allocation is referred to as MAP information. The MAP information includes resource allocation information in a certain resource region and is transmitted on a periodic basis. When not receiving the MAP information, the terminal may not know whether its allocated resource exists in the corresponding resource region, and thus may not communicate during the corresponding period. However, the MAP information only includes the resource allocation information of the corresponding resource region, that is, the MAP information is valid only in the corresponding resource region. For example, downlink MAP information transmitted in a k-th frame is valid only in the downlink interval of the k-th frame. Hence, even when no MAP information of the k-th frame is received, the terminal receiving the MAP information of the (k+1)-th frame is able to communicate in the (k+1)-th frame.

In general, the MAP information is valid only in the corresponding resource region. However, in special cases, the MAP information may be valid continuously. For instance, when a persistent allocation scheme is adopted to reduce overhead of the MAP information, the MAP information is valid in a plurality of resource regions. According to the persistent allocation, the terminal is assigned the resources of the same location continuously and the related MAP information is transmitted just once at the initial allocation. In the resource release, MAP information for the release is transmitted one time. That is, if the allocation information according to the persistent allocation is transmitted when no MAP information is received, than the terminal may not recognize the resource allocation in spite of the reception of next MAP information. In addition, if the release information according to the persistent allocation is transmitted when no MAP information is received, than the terminal may not recognize the resource release despite the reception of next MAP information.

As discussed above, when the particular resource allocation scheme, such as persistent allocation, is applied, one reception failure of the MAP information is likely to keep the wrong resource information continuously. Therefore, what is needed is a method for increasing the likelihood of successful reception of the MAP information.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for increasing the likelihood of successful reception of MAP information in a broadband wireless communication system.

Another aspect of the present invention is to provide an apparatus and a method for informing a base station of whether a terminal receives MAP information in a broadband wireless communication system.

Yet another aspect of the present invention is to provide an apparatus and a method for implicitly allocating an orthogonal sequence to feed back the success or the failure of MAP information reception in a broadband wireless communication system.

Still another aspect of the present invention is to provide an apparatus and a method for a terminal to determine an orthogonal sequence implicitly allocated, without separate information, in a broadband wireless communication system.

In accordance with an aspect of the present invention, an operating method of a base station in a broadband wireless communication system is provided. The method includes allocating an orthogonal sequence to a MAP that requires ACKnowledge (ACK) transmission, transmitting the MAP that does not comprise allocation information of the orthogonal sequence, determining whether the orthogonal sequence is detected in an ACK channel allocated for a subframe that carries the MAP, and when the orthogonal sequence is detected, determining that the MAP was successfully received.

In accordance with another aspect of the present invention, an operating method of a terminal in a broadband wireless communication system is provided. The method includes, when successfully decoding a MAP, determining whether the MAP requires ACK transmission, when the MAP requires the ACK transmission, determining an orthogonal sequence allocated to the MAP without allocation information of the orthogonal sequence, and transmitting the orthogonal sequence over an ACK channel allocated to the MAP.

In accordance with yet another aspect of the present invention, an apparatus of a base station in a broadband wireless communication system is provided. The apparatus includes an allocator for allocating an orthogonal sequence to a MAP that requires ACK transmission, a transmitter for transmitting the MAP that does not comprise allocation information of the orthogonal sequence, and a detector for detecting the orthogonal sequence in an ACK channel allocated for a subframe that carries the MAP, and for determining that the MAP was successfully received when the orthogonal sequence is detected.

In accordance with still another aspect of the present invention, an apparatus of a terminal in a broadband wireless communication system is provided. The apparatus includes a decoder for, when a MAP is successfully decoded, determining whether the MAP requires ACK transmission, a determining for, when the MAP requires the ACK transmission, determining an orthogonal sequence allocated to the MAP without allocation information of the orthogonal sequence, and a transmitter for transmitting the orthogonal sequence over an ACK channel allocated to the MAP.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments the present invention will be more apparent from the following description taken in conjunction with the accompanying drawings, in which:

FIGS. 1A and 1B illustrate examples of a frame structure in a broadband wireless communication system according to an exemplary embodiment of the present invention;

FIGS. 2A and 2B illustrate examples of a MAP structure in a broadband wireless communication system according to an exemplary embodiment of the present invention;

FIGS. 3A and 3B illustrate examples of a MAP persistently valid in a broadband wireless communication system according to an exemplary embodiment of the present invention;

FIGS. 4A and 4B illustrate examples of an orthogonal sequence allocation in a broadband wireless communication system according to an exemplary embodiment of the present invention;

FIG. 5 illustrates an ACKnowledge (ACK) channel allocation in a broadband wireless communication system according to an exemplary embodiment of the present invention;

FIG. 6 illustrates an example of an orthogonal sequence allocation for two subframes allocated one ACK channel in a broadband wireless communication system according to an exemplary embodiment of the present invention;

FIG. 7 illustrates operations of a base station in a broadband wireless communication system according to an exemplary embodiment of the present invention;

FIG. 8 illustrates operations of a terminal in a broadband wireless communication system according to an exemplary embodiment of the present invention;

FIG. 9 illustrates a base station in a broadband wireless communication system according to an exemplary embodiment of the present invention; and

FIG. 10 illustrates a terminal in a broadband wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein may be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide a technique for increasing the likelihood of successful reception of MAP information reception in a broadband wireless communication system. Hereinafter, an Orthogonal Frequency Division Multiplexing (OFDM)/Orthogonal Frequency Division Multiple Access (OFDMA) wireless communication system is illustrated by way of example. Note that the present invention is applicable to other wireless communication systems.

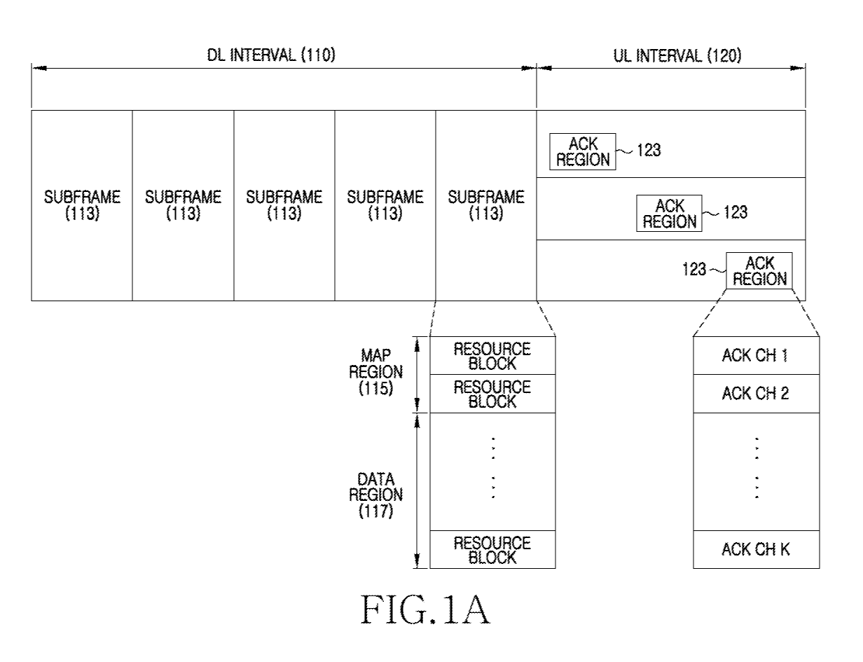

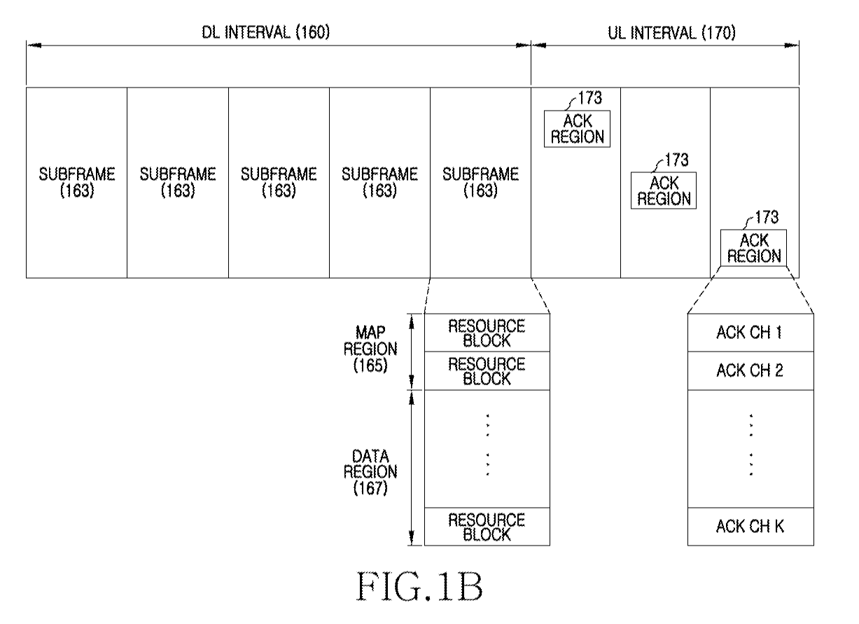

According to an exemplary embodiment of the present invention, a frame structure in a broadband wireless communication is illustrated in FIGS. 1A and 1B. FIGS. 1A and 1B depict two frame examples based on a subframe division manner of an uplink interval.

In FIG. 1A, the frame is divided into a downlink interval 110 and an uplink interval 120. The downlink interval 110 includes a plurality of subframes 113 divided in the time axis. Each subframe 113 includes a plurality of Resource Blocks (RBs). Some of the RBs are used as a MAP region 115 and the others are used as a data region 117. The uplink interval 120 is divided to a plurality of subframes in the frequency axis. Each subframe in the uplink interval 120 includes at least one ACKnowledge (ACK) region 123. Each ACK region 123 includes a plurality of ACK CHannels (CHs). Herein, one ACK CH is a resource required to transmit at least one ACK/Non-ACK (NACK). The number of the subframes 113 in the downlink interval 110 and in the uplink interval 120 varies depending on specific exemplary embodiments.

In FIG. 1B, the frame is divided into a downlink interval 160 and an uplink interval 170. The downlink interval 160 includes a plurality of subframes 163 divided in the time axis. Each subframe 163 includes a plurality of RBs. Some of the RBs are used as a MAP region 165 and the others are used as a data region 167. The uplink interval 170 includes a plurality of subframes divided in the time axis. Each subframe 163 in the uplink interval 170 includes at least one ACK region 173. Each ACK region 173 includes a plurality of ACK CHs. Herein, one ACK CH is a resource required to transmit at least one ACK/NACK. The number of subframes 163 in the downlink interval 160 and in the uplink interval 170 varies depending on specific exemplary embodiments.

According to the frame structure of FIGS. 1A and 1B, the ACK/NACK for the downlink data transmitted in the RBs of the downlink intervals 110 and 160 are fed back through one of the ACK CHs of the ACK regions 123 and 173 of the uplink intervals 120 and 170 in the same frame. Herein, the ACK regions 123 and 173 are positioned in different time axes. By designating the different ACK regions for the ACK/NACK transfer according to the location of the subframe used to transmit the downlink data, a delay time for processing the downlink data may be increased. More specifically, in FIGS. 1A and 1B, the subframes 113 and 163 of the downlink intervals 110 and 160 each have their corresponding ACK regions 123 and 173 respectively. For example, the ACK/NACK for the downlink data transmitted over the first subframe in the time axis is transmitted in the first ACK region in the time axis. The ACK/NACK for the downlink data transmitted in the last subframe in the time axis is transmitted over the last ACK region of the time axis. Additionally, to attain the diversity gain in the ACK/NACK transmission, one ACK CH may have a structure being repeated in different resources. For example, provided that the resource required to transfer one ACK/NACK is referred to as a tile, one ACK CH includes a plurality of tiles distributed over different physical bands. In doing so, the terminal may achieve the diversity gain by transmitting the ACK/NACKs through the tiles respectively.

In FIGS. 1A and 1B, the MAP regions 115 and 165 are provided for MAP information. The MAP information includes allocation information of the RBs in the corresponding subframes 113 and 163. The MAP information transmitted over the MAP regions 115 and 165 include a plurality of MAPs. One MAP indicates a single allocation. Each MAP is encoded to block terminals other than the destination terminal of the MAP from decoding the MAP. In more detail, each MAP is encoded and modulated at a Modulation and Coding Scheme (MCS) level that is known to the destination terminal of the MAP, and passes through Cyclic Redundancy Check (CRC) masking or CRC scrambling using a specific IDentifier (ID) assigned to the terminal. For example, a Connection ID (CID) may be used for the CRC processing. If necessary, the MAP may be decoded so as to be encoded by a plurality of terminals. In other words, the MAP may be multicast or broadcast. An example of the multicast or broadcast MAP includes a MAP informing of resource use status of a specific interval or a subframe. That is, the MAP informing of RBs in use and RBs out of use is multicast or broadcast. The MAP informing of the resource use status does not aim at the resource allocation to the particular terminal but intends to inform of the resource use information prior to the resource allocation.

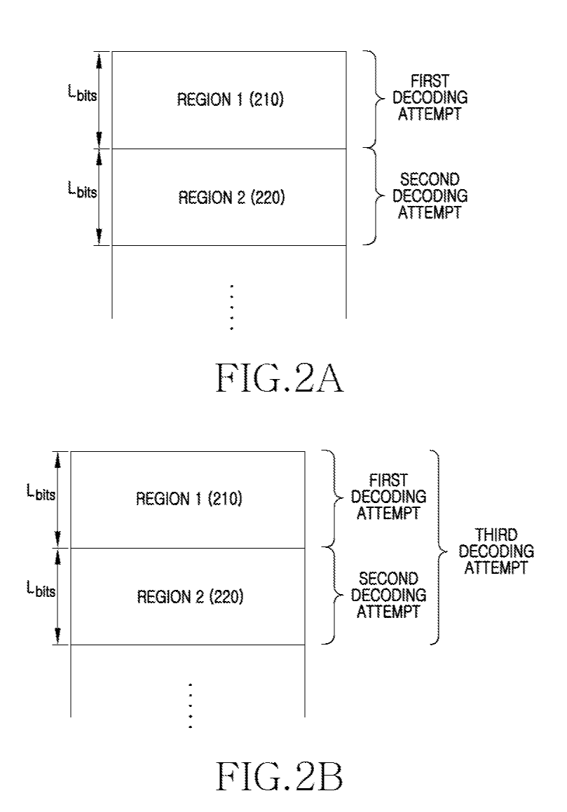

Accordingly, when the CRC masking or the CRC scrambling is applied to the MAP as mentioned above, each MAP does not include the ID of the terminal which should receive the MAP, that is, CID or Media Access Control Identifier (MACID). That is, when no CRC error is detected by checking the CRC on each MAP, the terminal estimates that the corresponding MAP is destined for itself. For doing so, the MAPs should be in the same size, or in the size which is the integral multiple of a predefined minimum size. For example, when all of the MAPs are in the L-bit size, the terminal attempts to decode the MAPs in the order as shown in FIG. 2A. The MAP is encoded in the same L-bit size in FIG. 2A. The terminal attempts the first MAP decoding in the first region 210 occupying the L bits from the start point of the subframe including the MAP, and the second MAP decoding in the second region 220 occupying the next L bits. Alternatively, when the MAPs are in the L-bit or 2 L-bit size, that is, when the MAPs are in the two sizes, the terminal attempts the MAP decoding in the order of FIG. 2B. In FIG. 2B, the terminal attempts the MAP decoding for two times in the first region 210 and the second region 220 in order and attempts the third MAP decoding in both of the first region 210 and the second region 220.

In a broadband wireless communication system according to an exemplary embodiment of the present invention, the ACK regions 123 and 173 are used to transmit not only the ACK/NACK for the downlink data but also ACK/NACK for the MAP. That is, the terminal sends the ACK/NACK for its received MAP over the ACK CH in the ACK regions 123 and 173. Yet, the transmission of the ACK/NACK is not required for all kinds of MAPs. The MAP that is valid throughout the plurality of the frames requires the transmission of the ACK/NACK. Hence, the terminal selectively sends the ACK/NACK according to the type of its received MAP. For example, the MAP for a synchronous Hybrid Automatic Repeat reQuest (HARQ) resource allocation and a MAP for a persistent resource allocation require the transmission of the ACK/NACK.

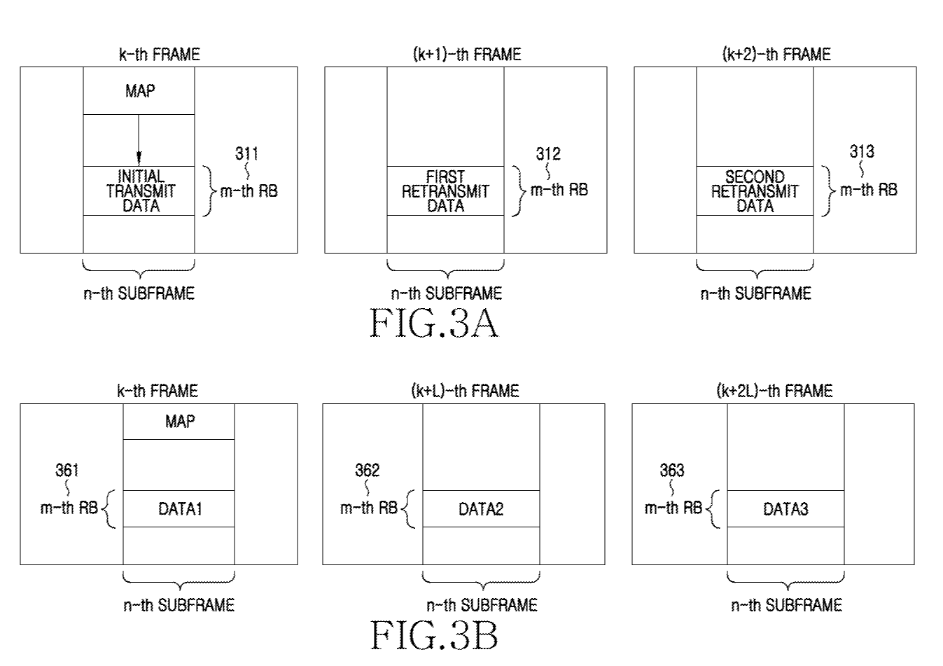

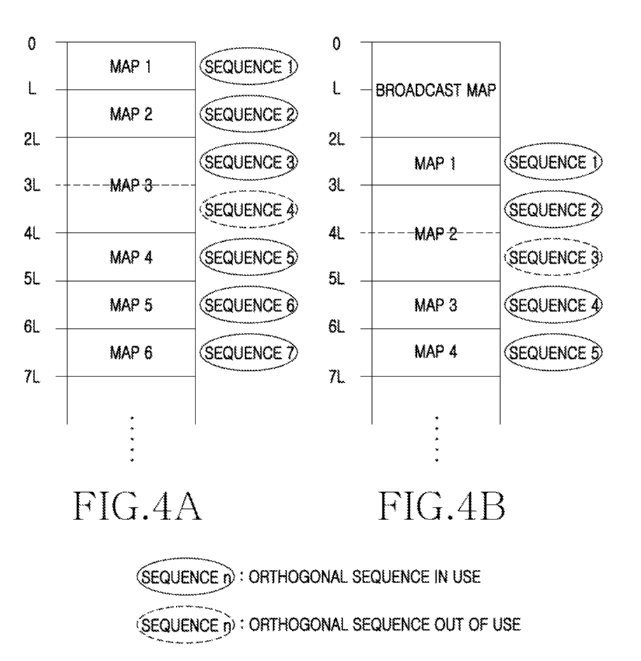

According to the synchronous HARQ, the retransmission data is transmitted through the resource of the same location as the resource used in the initial data transmission. For example, when the initial transmission data is sent over the m-th RB 311 of the n-th subframe of the k-th frame in FIG. 3A, the first retransmission data needs to be transmitted in the m-th RB 312 of the n-th subframe of the (k+1)-th frame and the second retransmission data needs to be transmitted in the m-th RB 313 of the n-th subframe of the (k+2)-th frame. In the n-th subframes of the (k+1)-th frame and the (k+2)-th subframe, the MAP for the retransmission data is not transmitted. Accordingly, when the MAP in the n-th subframe of the k-th frame is not received, the terminal may not receive the retransmission data as well.

The persistent allocation is suitable for a service that periodically generates traffic, such as a Voice over Internet Protocol (VoIP) service. According to the persistent allocation, the resource at the same location in frames is periodically allocated and the MAP indicative of the periodically allocated resource is transmitted only one time with the start of the allocation. For example, the terminal which is assigned the m-th RB 361 of the n-th subframe of the k-th frame as shown in FIG. 3B, receives data over the m-th RB 361 of the n-th subframe of the (k+L)-th frame and the m-th RB 361 of the n-th subframe of the (k+2 L)-th frame unless it receives a MAP indicative of a separate release or change.

The ACK/NACK for the MAP is transmitted in the form of an orthogonal sequence. As the ACK/NACK for MAP is in the form of the orthogonal sequence, a plurality of ACK/NACKs for the MAPs may be transmitted over a single ACK channel. For example, when the ACK channel includes 12 tones, 12 orthogonal sequences are generated. Hence, 12 ACK/NACKs at maximum may be concurrently transmitted over one ACK channel. In so doing, when the orthogonal sequences are used only for the ACK, that is, when the ACK is sent in the case of reception success and a NACK is not sent in the case of the reception failure, a single ACK channel may support 12 terminals at maximum. In contrast, when the orthogonal sequence is used for the ACK or the NACK, that is, when the ACK is sent in case of the reception success and the NACK is sent in case of the reception failure, one ACK channel may support 6 terminals at maximum.

To make use of the ACK/NACK in the form of the orthogonal sequence, the base station should allocate the orthogonal sequences to the terminals. However, the base station does not separately transmit the orthogonal sequence allocation information. Namely, the system in an exemplary embodiment of the present invention utilizes an implicit orthogonal sequence allocation scheme. According to the implicit orthogonal sequence allocation, the terminal determines its allocated orthogonal sequence based on the relative location of its MAP without the separate sequence allocation information. In other words, the terminal determines its allocated orthogonal sequence by comparing the preset order of the orthogonal sequences with its MAP location.

For example, when the MAP size is the integral multiple of the L bits, the correspondence of the orthogonal sequences based on the MAP location is shown in FIGS. 4A and 4B. Referring to FIG. 4A, the orthogonal sequences correspond to regions which divide the subframe on the L-bit basis. More specifically, MAP1 that occupies from the start point to the L-bit point of the subframe corresponds to sequence 1, and MAP2 that occupies the L-bit point to the 2 L-bit point of the subframe corresponds to sequence2. MAP3 that occupies from the 2 L-bit point to the 4 L-bit point of the subframe corresponds to sequence3, and MAP 4 that occupies the 4 L-bit point to the 5 L-bit of the subframe corresponds to sequence5. Sequence4 is not used. The terminals other than the terminal receiving the MAP3 do not know that the size of the MAP3 is 2 L bits, that is, determine that there are two L-bit sized MAPs between the 2 L point and the 4 L point. Hence, they determine that the sequence4 is allocated for the MAP occupying from the 3 L-bit point to the 4 L-bit point of the subframe.

When the MAP not requiring the ACK/NACK transmission is broadcast or multicast, the correspondence of the orthogonal sequences according to the location of the MAP is shown in FIG. 4B. For example, the broadcast or multicast MAP not requiring the ACK transmission may include a bitmap indicative of whether the RB is used in a certain interval or subframe. As shown in FIG. 4B, the region occupied by the broadcast MAP is excluded and the orthogonal sequences and the MAPs correspond to each other from the end point of the broadcast MAP in the same manner as in FIG. 4A. In this case, the base station allocates the orthogonal sequences starting from the end point of the broadcast MAP. The terminal recognizes the existence of the broadcast MAP by decoding the broadcast MAP and corresponds to the MAPs and the orthogonal sequences starting from the end point of the broadcast MAP.

The base station assigns the orthogonal sequences to the terminals for receiving the MAP as shown in FIGS. 4A and 4B. By placing the MAP requiring the ACK/NACK transmission above the MAP not requiring the ACK/NACK transmission, the base station may reduce the wasted orthogonal sequences. When its MAP needs the ACK/NACK transmission, the terminal determines its allocated orthogonal sequence as shown in FIGS. 4A and 4B. For example, when the MAP1 is successfully decoded and the MAP1 requires the ACK/NACK transmission, the terminal informs the base station of the successful reception by sending the orthogonal sequence1 as the ACK.

As the orthogonal sequence allocation information is determined as stated above, there is no need to send separate orthogonal sequence allocation information. Still, the base station should inform the terminals of the order of the orthogonal sequences. In other words, the information of which orthogonal sequence is indicated by the sequence 1 should be transmitted. Since the order information of the orthogonal sequences is common to all of the terminals, the order information may be transmitted over a Broadcast CHannel (BCH). The BCH is used to transfer system information required for the terminal intending to access the base station. The BCH is positioned at a predefined position within the frame.

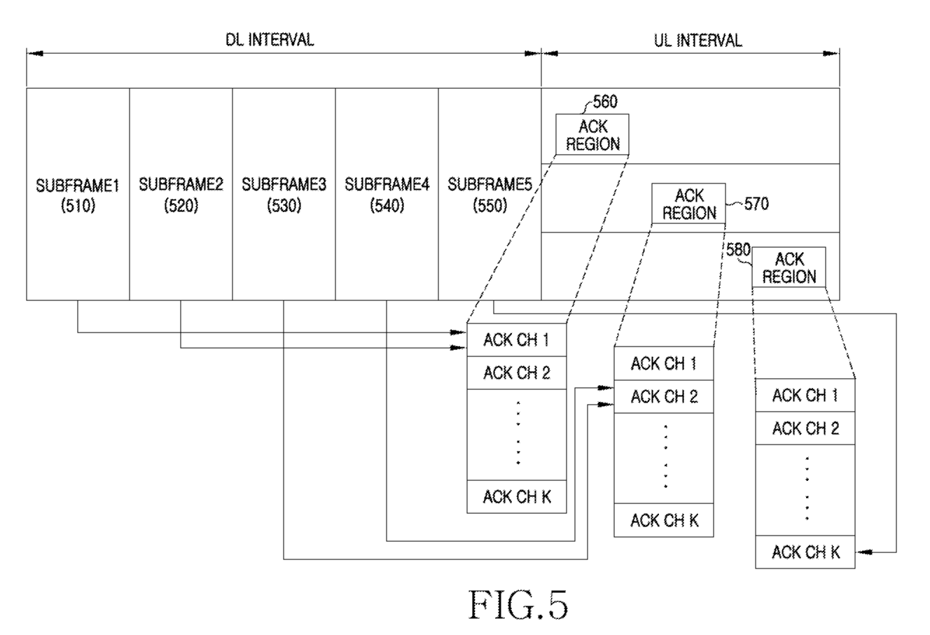

The base station needs to inform of which ACK channel carries the ACK/NACK for the MAP. The ACK channel allocation information may be transmitted over the BCH as well. In further detail, over the BCH, the base station transmits the ACH channel allocation information indicating which subframe MAP should use which ACK channel of which ACK region. Note that it is not always necessary that one subframe should correspond to one ACK channel. A plurality of ACK channels may be allocated to one subframe and one ACK channel be allocated to a plurality of subframes. An example of the ACK channel allocation is shown in FIG. 5. In FIG. 5, ACK CH1 of first ACK region 560 is allocated to subframe1 510 and subframe2 520, ACK CH2 of second ACK region 570 is allocated to subframe3 530 and subframe4 540, and ACK CHk of third ACK region 580 is allocated to subframe5 550. Correspondingly, the terminal receiving the MAP in subframe1 510 or the subframe2 520 sends the ACK/NACK for the MAP over the ACK CH 1 of the first ACK region 560. The terminal receiving the MAP in the subframe3 530 or the subframe4 540 sends the ACK/NACK for the MAP over the ACK CH2 of the second ACK region 570, and the terminal receiving the MAP in the subframe5 550 sends the ACK/NACK for the MAP over the ACK CHk of the third ACK region 580.

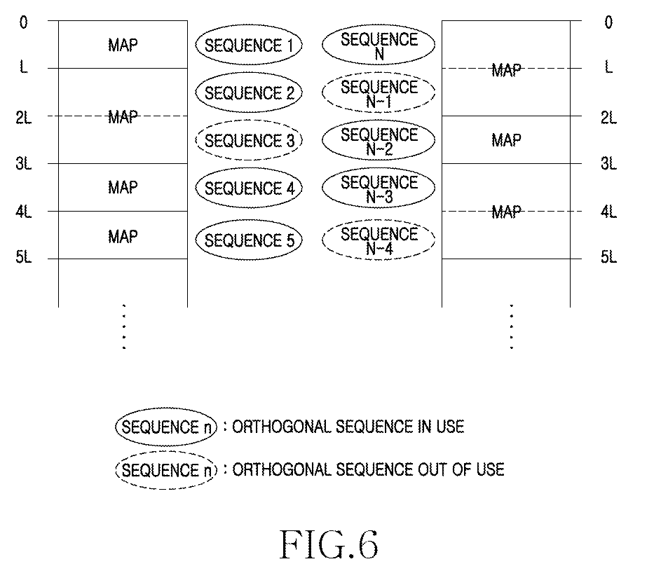

When a single ACK channel is allocated to a plurality of subframes, the base station needs to divide the orthogonal sequences to not overlap each other. For example, when N-ary orthogonal sequences are available and one ACK channel is allocated to two subframes, the base station allocates the orthogonal sequences of one subframe in the forward direction starting from the first orthogonal sequence and allocates the orthogonal sequences of the other subframe in the backward direction starting from the N-th orthogonal sequence as shown in FIG. 6.

As stated above, the MAP requiring the ACK transmission is persistently valid throughout the multiple frames. However, the MAP valid only in one frame may require the ACK transmission. For example, when the asynchronous HARQ is operated in an Incremental Redundancy (IR) manner, the MAP for the resource allocation of the first packet of the HARQ IR requires the ACK transmission.

According to the HARQ IR, the initial transmission packet is an original packet and retransmission packets after the initial transmission is parity information. Hence, when the reception of the initial transmission packet fails in the HARQ IR manner, its reception may succeed by combining with the retransmission packets. On the contrary, when the MAP informing of the resource allocation for the initial transmission packet is not received and thus the initial transmission packet is not received at all, the combination with the retransmission packets is impossible. Thus, when the asynchronous HARQ is operated in the IR manner, the MAP informing of the resource allocation for the initial transmission packet requires the ACK transmission. For this reason, the MAP for the resource allocation of the asynchronous HARQ based on the IR is treated as the MAP requiring the ACK transmission.

Now, descriptions explaining operations of the base station and the terminal which transmit and receive the ACK of the MAP as described above are made below with reference to the drawings.

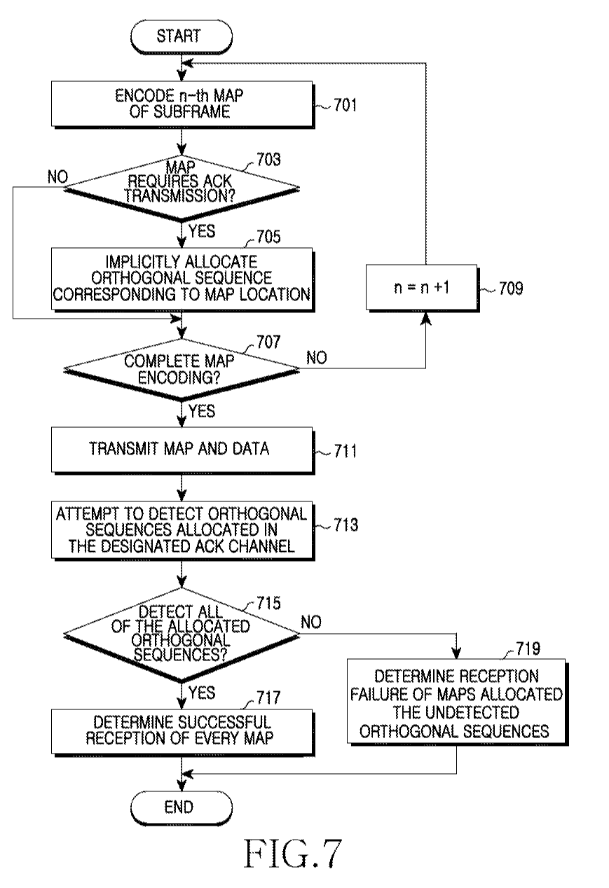

FIG. 7 illustrates operations of a base station in a broadband wireless communication system according to an exemplary embodiment of the present invention.

In step 701, the base station encodes the n-th MAP of the present subframe. In more detail, the base station generates the resource allocation information contained in the n-th MAP or information other than the resource allocation information, and CRC-processes the resource allocation information with the ID of the terminal which is to receive the n-th MAP. Herein, when this process commences, n is initialized to ‘1’.

In step 703, the base station determines whether the n-th MAP requires the ACK transmission. That is, the base station determines whether the n-th MAP is persistently valid or for the initial transmission of the asynchronous HARQ IR. For example, as for the MAP for the persistent resource allocation or the MAP for the synchronous HARQ resource allocation, the base station estimates the persistently valid MAP. When the n-th MAP does not require the ACK transmission, the base station proceeds to step 707.

In contrast, when the n-th MAP requires the ACK transmission, the base station implicitly allocates the orthogonal sequence corresponding to the location of the MAP in step 705. The base station divides the interval between the start point of the subframe and the start point of the n-th MAP by the minimum size of the MAP and allocates the {the result value of the division+1}-th orthogonal sequence to the n-th MAP. In so doing, when the broadcast MAP is positioned at the start point of the subframe, the interval between the end point of the broadcast MAP and the start point of the n-th MAP is used. When one ACK channel is allocated to two subframes and the backward allocation of the orthogonal sequences is applied to the subframes, the {the total number of the orthogonal sequences−the result value of the division}-th orthogonal sequence is allocated. In other words, when two subframes share one ACK channel, the base station allocates the orthogonal sequences in the forward direction in one subframe and allocates the orthogonal sequences in the backward direction in the other subframe.

In step 707, the base station determines whether the MAP encoding of the subframe is completed. When the MAP encoding is not completed, that is, when there still remains MAPs to encode, the base station increases n by ‘1’ in step 709 and returns to step 701.

When the MAP encoding is completed, the base station transmits the encoded MAPs and the data in step 711. More specifically, the base station demodulates and converts the MAPs and the data to complex symbols, constitutes OFDM symbols through an Inverse Fast Fourier Transform (IFFT) operation and Cyclic Prefix (CP) insertion, up-converts to a Radio Frequency (RF) signal, and then transmits the RF signal over an antenna. The MAP does not include the resource information of the orthogonal sequence.

In step 713, the base station attempts to detect the allocated orthogonal sequences in the designated ACK channel. In further detail, the base station correlates the signal received over the ACK channel allocated to the subframe and the assigned orthogonal sequences.

In step 715, the base station determines whether all of the allocated orthogonal sequences are detected. The base station determines whether the correlation value of the allocated orthogonal sequences is greater than a threshold. That is, when the correlation value is greater than the threshold, the detection is successful. When the correlation value is less than the threshold, the detection fails.

When all of the allocated orthogonal sequences are detected, the base station estimates that all of the MAPs requiring ACK transmission received over the subframe are successfully received in step 717.

In contrast, when part or all of the allocated orthogonal sequences are not detected, the base station determines that the reception of the MAPs of the undetected orthogonal sequences in step 719 failed. The base station then retransmits the MAPs assigned the undetected orthogonal sequences in the next frame.

Although it is not illustrated in FIG. 7, the determining of the encoding order of the MAPs may be added in FIG. 7. To reduce the number of wasted orthogonal sequences, the determining of the encoding order of the MAPs may be further included in order to encode the MAPs requiring the ACK transmission first. In this case, the base station determines the encoding order of the MAPs to encode the MAPs requiring the ACK transmission first and then proceeds to step 701.

The terminal receiving the MAP transmitted as described in FIG. 7 may determine whether the received MAP requires the ACK transmission, in the same manner as the base station. By determining whether the MAP is persistently valid, the terminal may determine whether the MAP requires the ACK transmission. However, to more clearly indicate whether the MAP requires the ACK transmission, an identifier indicating whether the MAP requires the ACK transmission may be added to the MAP. In this case, the base station includes the identifier to the MAP when encoding the MAP in step 701.

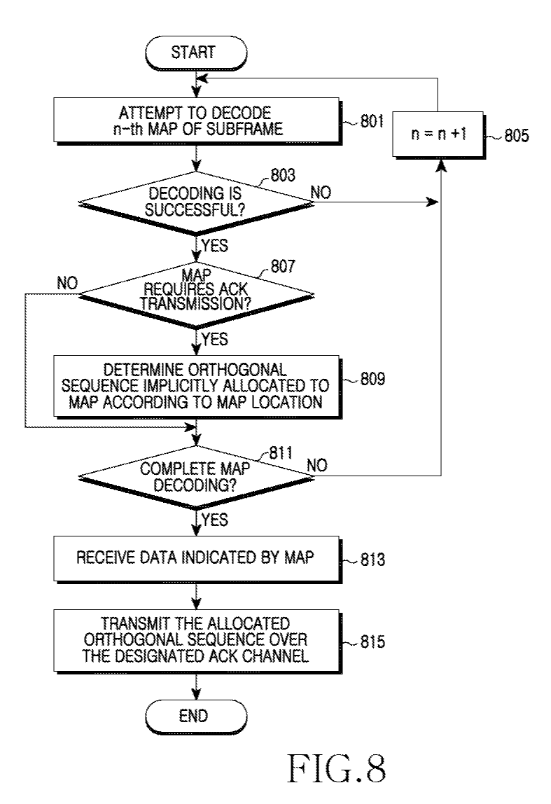

FIG. 8 illustrates operations of a terminal in a broadband wireless communication system according to an exemplary embodiment of the present invention.

In step 801, the terminal attempts to decode the n-th MAP of the subframe. The terminal checks the CRC with its ID in the n-th MAP. Herein, when this process commences, n is initialized to ‘1’.

In step 803, the terminal determines whether the decoding of the n-th MAP is successful. That is, the terminal determines whether no error is detected in the CRC check. When the decoding fails, the terminal increases n by ‘1’ in step 805 and goes back to step 805.

When the decoding is successful, the terminal determines whether the n-th MAP requires the ACK transmission in step 807. That is, the terminal determines whether the n-th MAP is persistently valid or for the initial transmission of the asynchronous HARQ IR. For example, as for the MAP for the persistent resource allocation and the MAP for the synchronous HARQ resource allocation, the terminal estimates the persistently valid MAP. When the n-th MAP does not require the ACK transmission, the terminal proceeds to step 811.

In contrast, when the n-th MAP requires the ACK transmission, the terminal determines the orthogonal sequence corresponding to the location of the n-th MAP and determines the allocation of the determined orthogonal sequence in step 809. Since the MAP does not contain the allocation information of the orthogonal sequence, the terminal determines the orthogonal sequence allocated for the n-th MAP without the allocation information of the orthogonal sequence. More specifically, the terminal divides the interval between the start point of the subframe and the start point of the n-th MAP by the minimum size of the MAP and determines that the {the result value of the division+1}-th orthogonal sequence is assigned to the n-th MAP. In so doing, when the broadcast MAP is positioned at the start point of the subframe, the interval between the end point of the broadcast MAP and the start point of the n-th MAP is used. When one ACK channel is assigned to two subframes and the backward allocation of the orthogonal sequences is applied to the subframes, the terminal determines that the {the total number of the orthogonal sequences−the result value of the division}-th orthogonal sequence is allocated.

In step 811, the terminal determines whether the MAP decoding is completed. When the MAP decoding is not finished, that is, when an additional MAP decoding attempt is necessary, the terminal increases n by ‘1’ in step 805 and returns to step 801.

When the MAP decoding is completed, the terminal receives the data indicated by its MAP in step 813. That is, the terminal extracts the signal mapped to the RB indicated by its MAP, demodulates and decodes the extracted signal.

In step 815, the terminal transmits the allocated orthogonal sequence over the designated ACK channel. In more detail, the terminal maps the orthogonal sequence allocated to its MAP to the ACK channel assigned to the subframe, constitutes OFDM symbols through an IFFT operation and the CP insertion, up-converts into an RF band, and transmits the RF signal over an antenna.

In FIG. 8, the terminal determines whether the MAP requires the ACK transmission by determining whether the MAP is persistently valid. To more clearly indicate whether the MAP requires the ACK transmission, the base station may add an identifier indicating whether the MAP requires the ACK transmission. In this case, the terminal determines whether the MAP requires the ACK transmission by determining whether the MAP includes the identifier in step 807.

Now, exemplary structures of the base station and the terminal for transmitting and receiving the ACK of the MAP as described above are described with reference to the drawings.

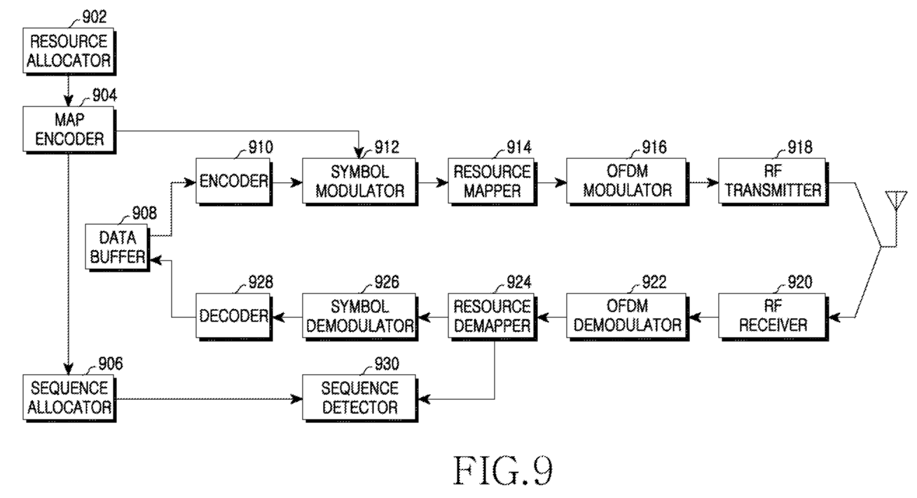

FIG. 9 is a block diagram of a base station in a broadband wireless communication system according to an exemplary embodiment of the present invention.

Referring to FIG. 9, the base station includes a resource allocator 902, a MAP encoder 904, a sequence allocator 906, a data buffer 908, an encoder 910, a symbol modulator 912, a resource mapper 914, an OFDM modulator 916, an RF transmitter 918, an RF receiver 920, an OFDM demodulator 922, a resource demapper 924, a symbol demodulator 926, a decoder 928, and a sequence detector 930.

The resource allocator 902 allocates resources to terminals. The resource allocator 902 performs the resource allocation per subframe and provides the resource allocation result of each subframe to the MAP encoder 904.

The MAP encoder 904 generates MAPs for delivering the resource allocation result provided from the resource allocator 902 to the terminals. Each MAP includes the resource allocation information for one terminal and passes through CRC processing with the ID of the terminal that is to receive the MAPs. That is, the MAP encoder 904 generates resource allocation information indicative of the resource allocation result and CRC-processes the resource allocation information with the ID of the corresponding terminal. The MAP encoder 904 determines whether each MAP requires the ACK transmission. When the MAP requiring the ACK transmission is encoded, the MAP encoder 904 provides the sequence allocator 906 with the location information of the MAP requiring the ACK transmission. To reduce the number of wasted orthogonal sequences, a function for determining the encoding order of the MAPs may be further included in order to encode the MAPs requiring the ACK transmission first. In this case, the MAP encoder 904 determines the encoding order of the MAPs to encode the MAPs requiring the ACK transmission first and then encodes the MAPs. To more clearly indicate whether the MAP requires the ACK transmission, an identifier indicating whether the MAP requires the ACK transmission may be added to the MAP. In this case, the MAP encoder 904 includes the identifier in the MAP when encoding the MAP requiring the ACK transmission. At this time, the MAP does not contain the allocation information of the orthogonal sequence.

The sequence allocator 906 implicitly allocates the orthogonal sequence to the MAP requiring the ACK transmission. The sequence allocator 906 determines the location information of the MAP in the subframe provided from the MAP encoder 904 and implicitly allocates the orthogonal sequence corresponding to the MAP location to the MAP. More specifically, the sequence allocator 906 divides the interval between the start point of the subframe and the start point of the MAP by the minimum size of the MAP, and allocates the {the result value of the division+1}-th orthogonal sequence to the MAP. In so doing, when the broadcast MAP is positioned at the start point of the subframe, the interval between the end point of the broadcast MAP and the start point of the MAP is used. When one ACK channel is assigned to two subframes and the backward allocation of the orthogonal sequences is applied to the subframes, the {the total number of the orthogonal sequences−the result value of the division}-th orthogonal sequence is allocated. In other words, when two subframes share one ACK channel, the sequence allocator 906 allocates the orthogonal sequences in the forward direction in one subframe and allocates the orthogonal sequences in the backward direction in the other subframe.

The data buffer 910 stores the data to transmit to the terminal and the data received from the terminal. The data buffer 910 forwards the data to transmit according to the resource allocation result of the resource allocator 902, to the encoder 910. The encoder 910 encodes the data bit stream output from the data buffer 910. The symbol modulator 912 modulates the encoded bit stream output from the encoder 910 and converts it into complex symbols. The resource mapper 914 maps the complex symbols output from the symbol modulator 912 into the frequency domain. The OFDM modulator 916 converts the frequency-domain signals to time-domain signals through the IFFT and constitutes OFDM symbols by inserting a CP. The RF transmitter 918 converts the baseband signal output from the OFDM modulator 916 into an RF signal and transmits the RF signal via an antenna.

The RF receiver 920 converts an RF signal received via the antenna into a baseband signal. The OFDM demodulator 922 divides the baseband signal output from the RF receiver 920 on the OFDM symbol basis, removes the CP, and restores the frequency-domain signals through a Fast Fourier Transform (FFT). The resource demapper 924 classifies the frequency-domain signals output from the OFDM demodulator 922 based on the processing unit, provides the signal received over the ACK channel to the sequence detector 930, and provides the signal received over the traffic channel to the symbol demodulator 926. The symbol demodulator 926 demodulates the signals output from the resource demapper 924 and converts to the encoded bit stream. The decoder 928 decodes the encoded bit stream output from the symbol demodulator 926.

The sequence detector 930 attempts to detect the orthogonal sequences assigned by the sequence allocator 906 from the signal received over the ACK channel. That is, the sequence detector 930 correlates the signal received in the ACK channel allocated to the particular subframe with the orthogonal sequences allocated to the subframe respectively, and determines whether the correlation value of the allocated orthogonal sequences is greater than the threshold. When the correlation value is greater than the threshold, the detection is successful. When the correlation value is less than the threshold, the detection fails. As for the MAP assigned the detected orthogonal sequence, the sequence detector 930 determines that there was successful reception. As for the MAP assigned the undetected orthogonal sequence, the sequence detector 930 determines that there was a reception failure.

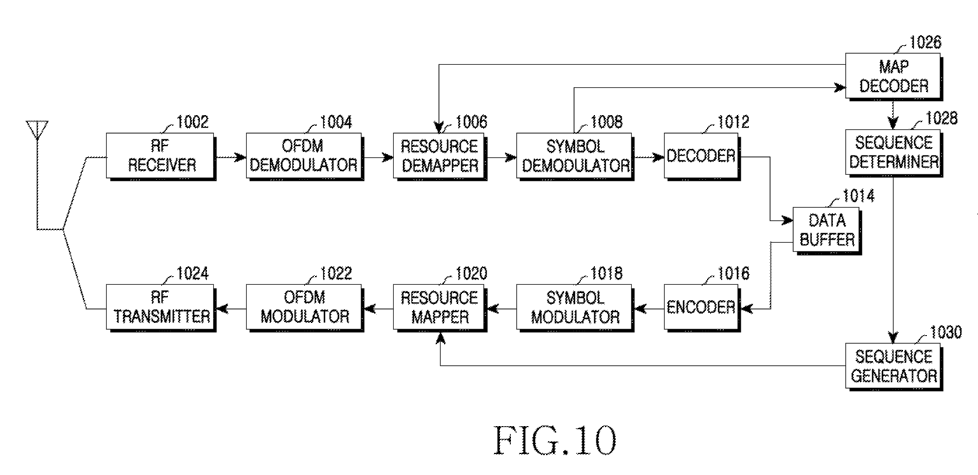

FIG. 10 is a block diagram of a terminal in a broadband wireless communication system according to an exemplary embodiment of the present invention.

Referring to FIG. 10 the terminal includes an RF receiver 1002, an OFDM demodulator 1004, a resource demapper 1006, a symbol demodulator 1008, a decoder 1012, a data buffer 1014, an encoder 1016, a symbol modulator 1018, a resource mapper 1020, an OFDM modulator 1022, an RF transmitter 1024, a MAP decoder 1026, a sequence determiner 1028, and a sequence generator 1030.

The RF receiver 1002 converts the RF signal received via an antenna into a baseband signal. The OFDM demodulator 1004 divides the baseband signal output from the RF receiver 1002 on an OFDM symbol basis, removes a CP, and restores the frequency-domain signals through an FFT. The resource demapper 1006 provides the symbol demodulator 1008 with the signal received in the MAP region and the signal received through the resource at the location indicated by the MAP decoder 1026 among the frequency-domain signals output from the OFDM demodulator 1008. The symbol demodulator 1008 demodulates and converts the signals output from the resource demapper 1006 into a bit stream. The symbol demodulator 1008 outputs the bit stream acquired from the signal received in the MAP region to the MAP decoder 1026, and outputs the bit stream acquired from the signal received in the traffic channel to the decoder 1012. The decoder 1012 decodes the bit stream fed from the symbol demodulator 1008.

The data buffer 1014 stores the data to transmit to the base station and the data received from the base station. The data buffer 1014 provides the data to transmit to the encoder 1016. The encoder 1016 encodes the data bit stream output from the data buffer 1014. The symbol modulator 1018 modulates the encoded bit stream output from the encoder 1016 and converts it into complex symbols. The resource mapper 1020 maps the complex symbols output from the symbol modulator 1018 into the frequency domain. The OFDM modulator 1022 converts the frequency-domain signals into time-domain signals through an IFFT and constitutes OFDM symbols by inserting the CP. The RF transmitter 1024 converts the baseband signal output from the OFDM modulator 1022 into an RF signal and transmits the RF signal via an antenna.

The MAP decoder 1026 attempts to decode the bit stream received over the MAP region on the MAP size basis. That is, the MAP decoder 1026 checks a CRC on the MAP-sized bit stream using its ID. When no error is detected when checking the CRC, the MAP decoding is successful. When error is detected, the MAP decoding fails. When the MAP decoding is successful, the MAP decoder 1026 determines whether the successfully decoded MAP requires the ACK transmission. In other words, the MAP decoder 1026 determines whether the successfully decoded MAP is persistently valid throughout the multiple frames or for the initial transmission of the asynchronous HARQ IR. For example, the MAP which is persistently valid throughout the multiple frames is used for the persistent resource allocation or the synchronous HARQ resource allocation. When the base station adds the identifier indicating whether the MAP requires the ACK transmission to the MAP to more clearly indicate whether the MAP requires the ACK transmission, the MAP decoder 1026 determines whether the MAP requires the ACK transmission by determining whether the MAP contains the identifier. When the successfully decoded MAP requires the ACK transmission, the MAP decoder 1026 provides the location information of the MAP to the sequence determiner 1028. The MAP decoder 1026 locates the resource indicated by the MAP and informs the resource demapper 1006 of the resource location.

The sequence determiner 1028 determines the orthogonal sequence implicitly allocated to the MAP requiring the ACK transmission. Since the MAP does not contain the allocation information of the orthogonal sequence, the sequence determiner 1028 determines the orthogonal sequence allocated to the MAP without the allocation information of the orthogonal sequence. More specifically, the sequence determiner 1028 determines the location information of the MAP in the subframe provided from the MAP decoder 1026 and determines the orthogonal sequence corresponding to the MAP location. The sequence determiner 1028 divides the interval between the start point of the subframe and the start point of the MAP by the minimum size of the MAP, and determines that the {the result value of the division+1}-th orthogonal sequence is allocated to the MAP. In so doing, when the broadcast MAP is positioned at the start point of the subframe, the interval between the end point of the broadcast MAP and the start point of the MAP is used. When one ACK channel is assigned to two subframes and the backward allocation of the orthogonal sequences is applied to the subframes, the sequence determiner 1028 determines the allocation of {the total number of the orthogonal sequences−the result value of the division}-th orthogonal sequence.

The sequence generator 1030 outputs a signal constituted with the orthogonal sequence determined by the sequence determiner 1028, to the resource mapper 1020. The sequence generator 1030 converts the orthogonal sequence output from the sequence determiner 1028 into a signal to be mapped to the resource, and provides the signal to the resource mapper 1020. Hence, the resource mapper 1020 maps the signal to the ACK channel assigned to the subframe of the received MAP requiring the ACK transmission.

As set forth above, by feeding back the success or the failure of the MAP information reception using the implicitly allocated orthogonal sequence in the broadband wireless communication system, the likelihood of successful reception of the MAP information may be increased.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An operating method of a base station in a wireless communication system, the method comprising:
allocating an orthogonal sequence to a MAP that requires ACKnowledge (ACK) transmission;
transmitting the MAP that does not comprise allocation information of the orthogonal sequence;
determining whether the orthogonal sequence is detected in an ACK channel allocated for a subframe that carries the MAP; and
determining that the MAP is successfully received when the orthogonal sequence is detected.

2. The method of claim 1, further comprising:
estimating one of a MAP persistently valid throughout a plurality of subframes and a MAP for an initial transmission of an asynchronous Hybrid Automatic Repeat reQuest (HARQ) Incremental Redundancy (IR) scheme, as a MAP requiring the ACK transmission.

3. The method of claim 2, wherein the MAP persistently valid throughout the frames comprises one of a MAP for persistent resource allocation and a MAP for synchronous HARQ resource allocation.

4. The method of claim 1, wherein the allocating of the orthogonal sequence comprises:
determining a location of the MAP in the subframe; and
allocating the orthogonal sequence corresponding to the location of the MAP.

5. The method of claim 4, wherein the allocating of the orthogonal sequence comprises:
dividing an interval between a start point of the subframe and a start point of the MAP by a minimum size of the MAP; and
allocating a {a result value of the division+1}-th orthogonal sequence.

6. The method of claim 4, wherein the allocating of the orthogonal sequence comprises:
dividing an interval between an end point of a broadcast MAP and a start point of the MAP by a minimum size of the MAP; and
allocating a {a result value of the division+1}-th orthogonal sequence.

7. The method of claim 4, wherein the allocating of the orthogonal sequence comprises:
dividing an interval between a start point of the subframe and a start point of the MAP by a minimum size of the MAP; and
allocating a {a total number of orthogonal sequences−a result value of the division}-th orthogonal sequence.

8. The method of claim 4, wherein the allocating of the orthogonal sequence comprises:
when two subframes share one ACK channel, allocating orthogonal sequences of one subframe in a forward direction and allocating orthogonal sequences of the other subframe in a backward direction.

9. The method of claim 1, further comprising:
when encoding the MAP, including an identifier in the MAP that indicates that the ACK transmission is required.

10. An operating method of a terminal in a wireless communication system, the method comprising:
determining whether the MAP requires ACKnowledge (ACK) transmission when successfully decoding a MAP;
determining an orthogonal sequence allocated to the MAP without allocation information of the orthogonal sequence when the MAP requires the ACK transmission; and
transmitting the orthogonal sequence over an ACK channel allocated to the MAP.

11. The method of claim 10, wherein the determining of whether the MAP requires the ACK transmission comprises:
when the MAP comprises one of a MAP persistently valid throughout a plurality of subframes and a MAP for an initial transmission of an asynchronous Hybrid Automatic Repeat reQuest (HARQ) Incremental Redundancy (IR) scheme, determining that the MAP requires the ACK transmission.

12. The method of claim 11, wherein the MAP persistently valid throughout the frames comprises one of a MAP for persistent resource allocation and a MAP for synchronous HARQ resource allocation.

13. The method of claim 10, wherein the determining of the orthogonal sequence allocated to the MAP comprises:
determining a location of the MAP in the subframe; and
determining the orthogonal sequence corresponding to the location of the MAP.

14. The method of claim 13, wherein the determining of the orthogonal sequence allocated to the MAP comprises:
dividing an interval between a start point of the subframe and a start point of the MAP by a minimum size of the MAP; and
determining the allocation of a {a result value of the division+1}-th orthogonal sequence.

15. The method of claim 13, wherein the determining of the orthogonal sequence allocated to the MAP comprises:
dividing an interval between an end point of a broadcast MAP and a start point of the MAP by a minimum size of the MAP; and
determining the allocation of a {a result value of the division+1}-th orthogonal sequence.

16. The method of claim 13, wherein the determining of the orthogonal sequence allocated to the MAP comprises:
dividing an interval between a start point of the subframe and a start point of the MAP by a minimum size of the MAP; and
determining the allocation of a {a total number of orthogonal sequences−a result value of the division}-th orthogonal sequence.

17. The method of claim 10, wherein the determining of whether the MAP requires the ACK transmission comprises:
determining whether the MAP requires the ACK transmission by using an identifier in the MAP that indicates that the ACK transmission is required.

18. An apparatus of a base station in a wireless communication system, the apparatus comprising:
an allocator for allocating an orthogonal sequence to a MAP that requires ACKnowledge (ACK) transmission;
a transmitter for transmitting the MAP that does not comprise allocation information of the orthogonal sequence; and
a detector for detecting the orthogonal sequence in an ACK channel allocated for a subframe that carries the MAP, and for determining that the MAP was successfully received when the orthogonal sequence is detected.

19. The apparatus of claim 18, further comprising:
an encoder for estimating one of a MAP persistently valid throughout a plurality of subframes and a MAP for an initial transmission of an asynchronous Hybrid Automatic Repeat reQuest (HARQ) Incremental Redundancy (IR) scheme, as a MAP requiring the ACK transmission.

20. The apparatus of claim 19, wherein the MAP persistently valid throughout the frames comprises one of a MAP for persistent resource allocation and a MAP for synchronous HARQ resource allocation.

21. The apparatus of claim 18, wherein the allocator confirms a location of the MAP in the subframe and allocates the orthogonal sequence corresponding to the location of the MAP.

22. The apparatus of claim 21, wherein the allocator divides an interval between a start point of the subframe and a start point of the MAP by a minimum size of the MAP, and allocates a {a result value of the division+1}-th orthogonal sequence.

23. The apparatus of claim 21, wherein the allocator divides an interval between an end point of a broadcast MAP and a start point of the MAP by a minimum size of the MAP, and allocates a {a result value of the division+1}-th orthogonal sequence.

24. The apparatus of claim 21, wherein the allocator divides an interval between a start point of the subframe and a start point of the MAP by a minimum size of the MAP, and allocates a {a total number of orthogonal sequences−a result value of the division}-th orthogonal sequence.

25. The apparatus of claim 21, wherein, when two subframes share one ACK channel, the allocator allocates orthogonal sequences of one subframe in a forward direction and allocates orthogonal sequences of the other subframe in a backward direction.

26. The apparatus of claim 19, further comprising:
an encoder for including an identifier in the MAP that indicates that the ACK transmission is required, when the MAP is encoded.

27. An apparatus of a terminal in a wireless communication system, the apparatus comprising:
a decoder for determining whether the MAP requires ACKnowledge (ACK) transmission when a MAP is successfully decoded;
a determiner for determining an orthogonal sequence allocated to the MAP without allocation information of the orthogonal sequence when the MAP requires the ACK transmission; and
a transmitter for transmitting the orthogonal sequence over an ACK channel allocated to the MAP.

28. The apparatus of claim 27, wherein, when the MAP comprises one of a MAP persistently valid throughout a plurality of subframes and a MAP for an initial transmission of an asynchronous Hybrid Automatic Repeat reQuest (HARQ) Incremental Redundancy (IR) scheme, the decoder determines that the MAP requires the ACK transmission.

29. The apparatus of claim 28, wherein the MAP persistently valid throughout the frames comprises one of a MAP for persistent resource allocation and a MAP for synchronous HARQ resource allocation.

30. The apparatus of claim 27, wherein the determiner determines a location of the MAP in the subframe and determines the orthogonal sequence corresponding to the location of the MAP.

31. The apparatus of claim 30, wherein the determiner divides an interval between a start point of the subframe and a start point of the MAP by a minimum size of the MAP, and determines the allocation of a {a result value of the division+1}-th orthogonal sequence.

32. The apparatus of claim 30, wherein the determiner divides an interval between an end point of a broadcast MAP and a start point of the MAP by a minimum size of the MAP, and determines the allocation of a {a result value of the division+1}-th orthogonal sequence.

33. The apparatus of claim 30, wherein the determiner divides an interval between a start point of the subframe and a start point of the MAP by a minimum size of the MAP, and determines the allocation of a {a total number of orthogonal sequences−a result value of the division}-th orthogonal sequence.

34. The apparatus of claim 27, wherein the decoder determines whether the MAP requires the ACK transmission by using an identifier in the MAP that indicates that the ACK transmission is required.
